(19) United States
(12) Patent Application Publication
(10) Pub. No.: US 2020/0318974 A1
(43) Pub. Date: Oct. 8, 2020

(54) SYSTEM AND METHOD FOR INDOOR LOCATION COMPUTATION OF A USER DEVICE

(71) Applicant: IDRiSi Indoor Location Solution, Inc., Nazareth (IL)

(72) Inventor: Loai Abdullah, Kfar Yaseef (IL)

(73) Assignee: IDRiSi Indoor Location Solution, Inc., Nazareth (IL)

(21) Appl. No.: 16/376,554

(22) Filed: Apr. 5, 2019

(51) Int. Cl. G01C 21/20; H04W 4/024; H04W 4/029

(52) U.S. Cl. CPC G01C 21/206; H04W 4/029; H04W 4/024

(57) ABSTRACT

The system and method provide methods and devices that compute the indoor location of a user device with improved accuracy and reduced runtime complexity. A method for determining an indoor location of a user device may be done by a server. According to the method, the server measures quality of each of a plurality of calibration points stored in the server. The measurement of the quality includes calculation of a first distance from each of the plurality of calibration points to each other calibration point of the plurality of calibration points, calculation of a second distance from each of the plurality of calibration points to each other calibration point of the plurality of calibration points, and determination of a correlation between the first distance and the second distance for each calibration point of the plurality of calibration points.

### TECHNICAL FIELD

The present disclosure relates generally to indoor location computation of a user device. In particular, the present disclosure relates to a system and method to select a set of qualitative and active calibration points and eliminate another set of calibration points, thereby determining an improved indoor location based on the selected qualitative and active calibration points.

### BACKGROUND

Locating a person or an object in an indoor space is typically referred to as indoor positioning. Indoor positioning is used for many applications that include indoor navigation such as providing direction to visitors in an exhibition and entity tracking such as tracking of patients/equipment in hospital and the like.

Conventionally, the techniques employed for indoor positioning include satellite based positioning, Received Signal Strength Indication (RSSI), fingerprinting techniques and the like. However, when a satellite based positioning technique, such as techniques used with a Global Positioning System (GPS), is used for indoor location computation, the results are not accurate due to degradation of quality of satellite signals in an indoor environment. Similarly, computation of the indoor location using RSS values results in poor accuracy due to multipath fading. Conventional fingerprinting techniques have several drawbacks, such as using inaccurate RSS values, which result in inaccurate indoor location computation.

Thus, there exists a need for an improved indoor positioning technique for indoor location computation of the user device. In particular, there is a need for a technique that can compute the indoor location more efficiently than above mentioned techniques and without introducing large errors/uncertainties in the location computation.

### SUMMARY

It is an object of the present disclosure to provide methods and devices which computes the indoor location of the user device with improved accuracy and reduced runtime complexity.

According to an aspect, there is provided a method for determining an indoor location of a user device by a server. According to the method, the server measures quality of each of a plurality of calibration points stored in the server. The measurement of the quality comprises calculation of a first distance from each of the plurality of calibration points to each other calibration point of the plurality of calibration points, calculation of a second distance from each of the plurality of calibration points to each other calibration point of the plurality of calibration points, and determination of a correlation between the first distance and the second distance for each calibration point of the plurality of calibration points. Further, according to the method, the server identifies a first set of calibration points from the plurality of calibration points having the quality less than a first threshold value, selects a remaining set of calibration points from the plurality of calibration points based on elimination of the first set of calibration points, and determines the indoor location of the user device based on a subset of the remaining set of calibration points of the plurality of calibration points.

According to another aspect, there is provided a system to determine an indoor location of a user device, which comprises one or more processors. The system further comprises an application executed by the one or more processors. The one or more processors may be configured to measure quality of each of a plurality of calibration points stored in a server. To measure the quality the one or more processors may be configured to calculate a first distance from each of the plurality of calibration points to each other calibration point of the plurality of calibration points, calculate a second distance from each of the plurality of calibration points to each other calibration point of the plurality of calibration points, and determine a correlation between the first distance and the second distance for each calibration point of the plurality of calibration points. The one or more processors may be further configured to identify a first set of calibration points from the plurality of calibration points having the quality less than a first threshold value, select a remaining set of calibration points from the plurality of calibration points based on elimination of the first set of calibration points, and determine the indoor location of the user device based on a subset of the remaining set of calibration points of the plurality of calibration points.

An advantage of the proposed technology is a mechanism to improve accuracy and reduce runtime complexity in computation of the indoor location of the user device.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that may include the claimed disclosure, and explain various principles and advantages of those embodiments.

FIG. 1 illustrates a block diagram of an indoor system in accordance with some embodiments of the present disclosure.

FIG. 2 illustrates an exemplary calibration matrix of the indoor system of FIG. 1 in accordance with some embodiments of the present disclosure.

FIG. 3 illustrates a flowchart of a method for determining indoor location of a user device in the indoor system of FIG. 1 in accordance with some embodiments of the present disclosure.

FIG. 4 illustrates a block diagram of a server for determining indoor location of the user device in the indoor system of FIG. 1 in accordance with some embodiments of the present disclosure.

killed artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The method components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Hereinafter, the preferred embodiments of the present disclosure will be described in conjunction with the accompanying drawings. It should be understood that the preferred embodiments described herein are only used to illustrate and explain the present disclosure and are not intended to limit the present disclosure.

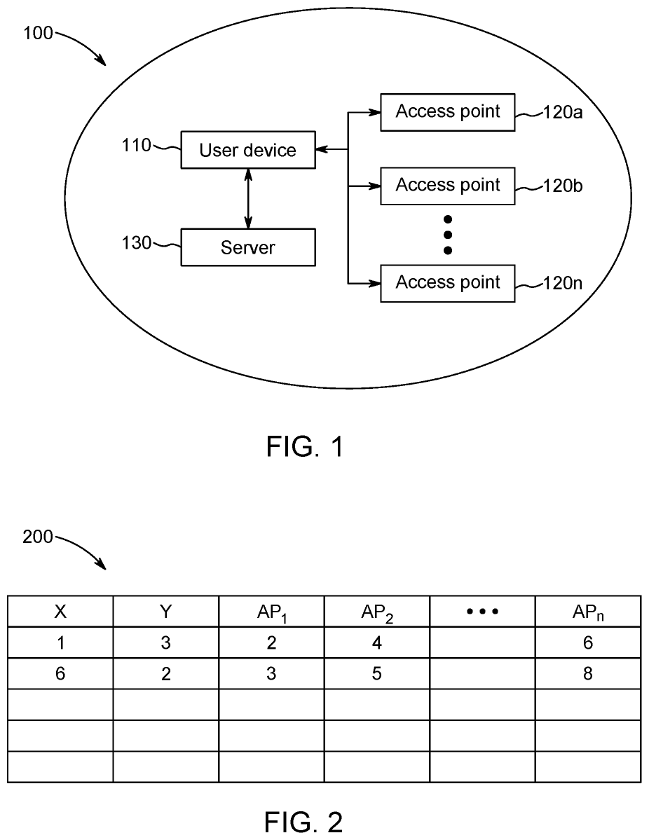

FIG. 1 illustrates a block diagram illustrating an indoor system 100 to determine a location of a user device 110 in the indoor system 100 in accordance with some embodiments. In accordance with another embodiment, the location of an object (not shown in FIG. 1) in the indoor system 100 may be determined. The object may include, but not limited to, doors, furniture, or the like. The indoor system 100 may be an enclosed space or building, where communication devices operate using a wired or wireless communication network. For example, the indoor system 100 can be a factory, office or exhibition or the like. The indoor system 100 may include the user device 110, a plurality of access points 120 (such as 120a, 120b . . . , 120n), and a server 130. According to the present system, the user device 110 and the access points 120 may be connected to the server 130 to determine location of the user device 110. The access points 120 may be distributed in the whole indoor system 100. The access points 120 can be used with different technologies based devices such as WiFi and Bluetooth low energy (BLE) devices, which transmit signals to and receive signals from the user device 110 and the server 130. The WiFi and BLE devices may be worked on different channel bandwidths and frequency bands. In an exemplary embodiment, the WiFi devices (802.11a/g) may be worked on channel bandwidth of 20 MHz, and frequency band 2.4 GHz. Similarly, the BLE devices may be worked on frequency band 2.4 GHz and transmission power −30 dBm to 4 dBm. The access points 120 communicate with each other either via wired or wireless communication links (not shown). The access points 120 may be configured to transmit signals to each spot (each indoor position) in the indoor system 100.

According to the present system, the user device 110 can be a communication device such as a mobile phone, smart phone, mobile node, radio terminal, personal digital assistant, tablet computer, laptop computer, or the like with communication capabilities. In accordance with some embodiments, the user device 110 may be configured to receive signals from the access points 120, and to measure, in real time, the RSS values from the received signals from the access points 120, to store the measured RSS values as calibration data in a calibration matrix D present in the server 130. In a preferred embodiment, the RSS values may lie in a range of −90 dBm and −30 dBm. The user device 110 may include on or more sensors to measure the RSS values, and the sensors may be built-in sensors within the user device 110 or may be provided externally. The measured RSS values may be uploaded to the server 130 from the user device 110 after receiving an instruction from a user. In another embodiment, the measured RSS values may be transferred automatically from the user device 110 to the server 130.

FIG. 6 illustrates another embodiment to determine the location of the object 630. The location of the object 630 may be determined by use of network gateways 620. In a preferred embodiment, the network gateways 620 may be included in the indoor system 600 (corresponding to indoor system 100 of FIG. 1). The network gateways 620 may be connected to the object 630 and the server 610 (corresponding to server 130 of FIG. 1) as shown in FIG. 6. The network gateways 620 may measure the RSS values to determine the location of the object 630. The object 630 may be configured to transmit signals in response to the signals transmitted by the access points 120. The signal transmission between the network gateways 620 and the object 630, or signal transmission between the network gateways 620 and the server 610 may be either wired or wireless. In accordance with other embodiment, the network gateways 620 may be a part of the server 610 or the network gateways may be located in the vicinity of the indoor system 600. To determine the location of the object 630, the network gateways 620 are used, which include one or more receiver sensors (not shown) that read the signals received from the object 630 and convert them to dBm values. In other words, the one or more receiver sensors of the network gateways 620 may measure the RSS values of the signals transmitted by the access points 120 to determine the location of the object 630. The measured RSS values may be uploaded to the server 610 from the network gateways 620 after receiving an instruction from the user. In another embodiment, the measured RSS values may be transferred automatically from the network gateways 620 to the server 610 to estimate the location of the object 630.

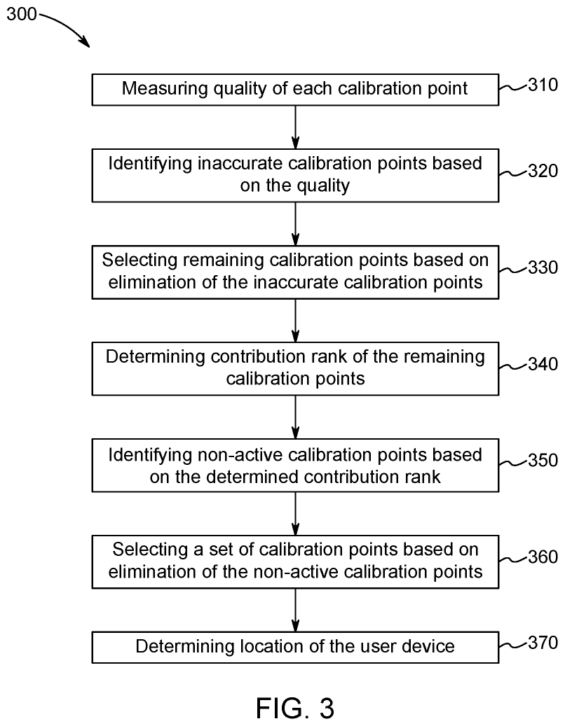

According to the present system, the server 130 may be configured to store and maintain the calibration matrix D (shown in FIG. 2). The calibration matrix D comprises fingerprint data for each spot in the indoor system 100. For each spot, the calibration matrix D may include longitudinal and latitude values as well as the RSS values of signals that may be received from each of the access points 120. The calibration matrix D may be a database constructed that stores the RSS values of the signals transmitted from the access points 120 to each spots of the indoor system 100 at a particular time interval. The calibration matrix D may include several data points. The data points may be termed as calibration points. In some embodiments, the server 130 may be connected to an external database, which may be maintained by a third party, to receive and store fingerprint data. According to the present system, the server 130 may receive measured RSS values from the user device 110 and estimates the location of the user device 110. The server 130 may be further configured to send the estimated location to the user device 110.

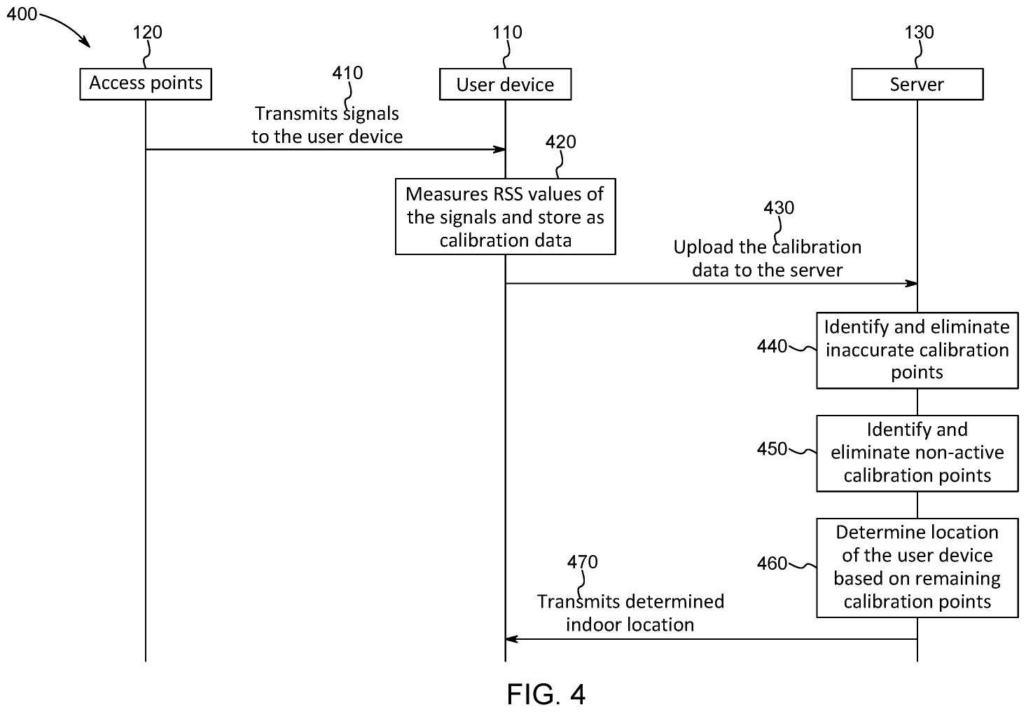

In accordance with some embodiments, the server 130 may measure, in conjunction with the description of FIG. 3, the quality of each of the plurality of calibration points, of the calibration matrix D, in the indoor system 100 and may identify a first set of calibration points from the plurality of calibration points that have quality less than a first threshold value. The server 130 may further select a remaining set of calibration points from the plurality of calibration points by eliminating the first set of calibration points. Upon elimination of the first set of calibration points, the server 130 may determine a contribution rank of each of the remaining set of calibration points and may identify a second set of calibration points from the remaining set of calibration points with the contribution rank less than a second threshold value. The server 130 may further select a third set of calibration points from the remaining set of calibration points based on elimination of the second set of calibration points to determine the location of the user device 110.

In accordance with some embodiments, to measure the quality of each of the plurality of calibration points, the server 130 may calculate a first distance from each of the plurality of calibration points to each other calibration point of the plurality of calibration points based on position coordinates of the plurality of calibration points. The server 130 may further calculate a second distance from each of the plurality of calibration points to each other calibration point of the plurality of calibration points based on received signal strength (RSS) values of signals received at each of the plurality of calibration points from the access points 120. The RSS values of signals received at each of the plurality of calibration points may be stored in the calibration matrix (as shown in FIG. 2) of the server 130. The server 130 may then determine a correlation between the first distance and the second distance for each calibration point of the plurality of calibration points, which may be specified in conjunction with description of FIG. 3.

In accordance with further embodiments, to determine the contribution rank of each of the remaining set of calibration points, the server 130 may calculate a distance from each of the remaining set of calibration points to each other remaining calibration points and may identify for each of the remaining set of calibration points, a set of nearest calibration points of the remaining calibration points of the plurality of calibration points, based on the calculated distance. The set of nearest calibration points may be determined based on a Euclidean distance from each of the remaining set of calibration points to each other remaining calibration points. The server 130 may then determine a number of times each of the remaining set of calibration points of the plurality of calibration points existing as a point in the set of nearest calibration points. The contribution rank of each of the remaining set of calibration points may correspond to the determined number of times.

FIG. 2 illustrates an exemplary calibration matrix D that may be stored in the server 130. The calibration matrix D may be a database constructed that stores fingerprint data for each spot in the indoor system 100. For each spot, the calibration matrix may include longitudinal and latitude values as well as the RSS values of signals that may be received from each of the access points 120. As shown in FIG. 2, the calibration matrix may be a matrix that may include multiple rows and columns to store the fingerprint data at each spot. The calibration matrix may store the longitude and latitude positioning of the calibration points (represented as x and yin FIG. 2). Further, the calibration matrix D may store RSS values of the signals received from the access points 120 at each spot. For example, RSS value of a signal received from a first access point 120a may be stored under AP₁ heading of the calibration matrix D as RSS1. Similarly, RSS values of signals received from different access points (120a, 120b . . . 120n) may be stored under respective headings as RSS1, RSS2 . . . RSSn. Each data points of the calibration matrix D may be termed as calibration points.

FIG. 3 illustrates a flowchart of a method 300 for determining location of the user device 110 in the indoor system 100 in accordance with some embodiments.

To determine the location of the user device 110, the indoor system 100 may include the access points 120 and the server 130. The user device 110 may receive signals from the access points 120 and may measure RSS values of the received signals. The measured RSS values may be then sent to the server 130 to store the measured RSS values as calibration data in the calibration matrix D. The calibration matrix D may be a database constructed to store the RSS values of the signals received from the access points 120 by the user device 110. The calibration matrix D may include several data points, and the data points are termed as calibration points.

At 310, the quality of each calibration point d, may be measured by the server 130. In accordance with some embodiments, the server 130 may perform the following operations, not necessarily in the order mentioned below, to measure the quality of each calibration points: 1. The server 130 may compute a first distance from each calibration point d, to every other calibration point dⱼ stored in the calibration matrix D based on the position coordinates. The position coordinates may comprise information about longitude and latitude positioning of the calibration points. The first distance may be a Euclidean distance from each calibration point dᵢ to every other calibration point dⱼ based on the position coordinates as shown in equation 1.

$$EucGeoDistance ( {d}_{i} , {d}_{j} ) = \sqrt{{( {longitude}_{i} - {longitude}_{j} )}^{2} + {( {latitude}_{i} - {latitude}_{j} )}^{2}} \qquad ( 1 )$$

Where EucGeoDistance (dᵢ, dⱼ) is the Euclidean distance from dᵢ to dⱼ based on the position coordinates (longitude/latitude),

dᵢ is one calibration point of the plurality of calibration points, where i=(1, 2 . . . m) and m denotes total number of calibration points stored in the calibration matrix D,

dⱼ is one calibration point of the other calibration points, where j=(1, 2 . . . m).

These distances are stored in a distances vector dist_{geo} ∈ [symbol] ^{m-1}, where [symbol] is a real number.

2. Based on the stored dist_{geo}, the server 130 may find λ nearest neighbors of dᵢ and stores them in ascending order of distance in nearest neighbors matrix Λ_{geo}, where Λ_{geo} may be a submatrix of D that may include the nearest calibrated points to a given calibration point dᵢ based on longitude/latitude values, and where first point in Λ_{geo} may be closest point to dᵢ. In an exemplary embodiment, the nearest calibration points may be stored in the following format:

TABLE 3.1

| | |
|---|---|
| Points → | d₁ |

| | | |
|---|---|---|
| Nearest | 1^{st} | d₃ |
| Neighbors | 2^{nd} | d₅ |
| (geo) | 3^{rd} | d₆ |

For example, in the above mentioned table λ=3 and Λ_{geo}(d₁) includes d₃, d₅, and d₆ (nearest neighbors of dᵢ).

3. The server 130 may further compute a second distance from each calibration point dᵢ to every other calibration point dⱼ based on the received signal strength (RSS) values stored in the calibration matrix D, where the RSS values may be the strength values of the signals received from the access points. The second distance may be a Euclidean distance from each calibration point dᵢ to every other calibration point dⱼ based on the RSS values as shown in equation 2.

$$EucRSSDistance ( {d}_{i} , {d}_{j} ) = \sqrt{{( RSS {1}_{i} - RSS {1}_{j} )}^{2} + {( RSS {2}_{i} - RSS {2}_{j} )}^{2} + … + {( {RSSn }_{i} - {RSSn}_{j} )}^{2}} \qquad ( 2 )$$

Where EucRSSDistance (dᵢ, dⱼ) is the Euclidean distance from dᵢ to dⱼ based on the RSS values,

RSS1, RSS2 . . . RSSn is signal strength values of the signals received from different access points (120a, 120b . . . 120n),

dᵢ is one calibration point of the plurality of calibration points, where i=(1, 2 . . . , m) and m denotes total number of calibration points stored in the calibration matrix D,

dⱼ is one calibration point of the other calibration points, where j=(1, 2, . . . , m).

These distances may be stored in a distances vector dist_{RSS} ∈ [symbol] ^{m-1}, where [symbol] is a real number.

4. Similarly, based on the stored dist_{RSS}, the server 130 may find λ nearest neighbors of dᵢ and store them in ascending order in nearest neighbors matrix Λ_{RSS}, where Λ_{RSS} may be a submatrix of D that may include the nearest calibrated points to a given calibration point dᵢ based on RSS values, and where first point in Λ_{RSS} may be closest point to dᵢ. In an exemplary embodiment, the nearest calibration points may be stored in the following format:

TABLE 3.2

| | |
|---|---|
| Points → | d₁ |

| | | |
|---|---|---|
| Nearest | 1^{st} | d₃ |
| Neighbors | 2^{nd} | d₅ |
| (RSS) | 3^{rd} | d₆ |

5. The server 130 may then determine a correlation between the Euclidean distance from each calibration point dᵢ to every other calibration point dⱼ calculated based on the position coordinates and the Euclidean distance from each calibration point dᵢ to every other calibration point dⱼ calculated based on the RSS values. In accordance with some embodiments, the server 130 may determine correlation between Λ_{geo} and Λ_{RSS} by computing sum square distances error between Λ_{geo} and Λ_{RSS} as shown in equation 3.

SSDE(Λ_{geo}, Λ_{RSS})=Σⱼ^{λ} Σᵢ^{λ}[EucGeoDistance(Λ_{geo}ⁱ, Λ_{RSS}^{j})]², (3)

Where SSDE(Λ_{geo}, Λ_{RSS}) is sum square distances error between Λ_{geo} and Λ_{RSS},

EucGeoDistance (Λ_{geo}ⁱ, Λ_{RSS}^{j}) is the Euclidean distance from Λ_{geo}ⁱ to Λ_{RSS}^{j} points based on the position coordinates (longitude/latitude), Λ_{geo}ⁱ, Λ_{RSS}^{j} denotes the i^{th} and the j^{th} points in Λ_{geo} and Λ_{RSS} respectively,

where i=(1, 2 . . . , m) and j=(1, 2, . . . , m),

λ is nearest neighbor of dᵢ.

In accordance with some embodiments, SSDE(Λ_{geo}ⁱ, Λ_{RSS}ⁱ) represents the correlation of Λ_{geo} and Λ_{RSS} computed for every calibration point dᵢ in the calibration matrix to determine the degree of similarity between the nearest neighbors that may be computed based on position coordinates and the nearest neighbors that may be computed based on RSS values. In other words, the correlation between Λ_{geo} and Λ_{RSS}, (SSDE(Λ_{geo}, Λ_{RSS}), may represent the extent to which the RSS values measured by the calibration point reflects the geometrical location of the indoor system 100 , which further represent the quality of the calibration points.

Next, at 320, identification of a first set of calibration points, from the plurality of calibration points, having quality (represented by SSDE(Λ_{geo}, Λ_{RSS})) less than a first threshold value may be performed by the server 130. In accordance with some embodiments, the calibration points with higher SSDE values (i.e. with quality less than the first threshold value) may be identified as inaccurate calibration points. On the other hand, the calibration points with lower SSDE values (i.e. with quality greater than the first threshold value) may be identified as qualitative calibration points having better quality that can be used to determine the location of the user device 110 accurately. In an exemplary embodiment, the server 130 may identify the first set of calibration points based on the lowest 25% of all SSDE's measurements.

Next, at 330, upon identification of the first set of calibration points with quality less than the first threshold value, the server 130 may eliminate the first set of calibration points, from the calibration matrix D, for usage in determination of the location of the user device 110. A remaining set of calibration points from the plurality of calibration points may be then selected. In accordance with some embodiments, the server 130 may eliminate the identified lowest quality calibration points with SSDE values less than the first threshold value, from the calibration matrix D since these calibration points have high probability that the RSS values measured by these calibration points do not accurately reflect the geometrical location. As a result, the lowest quality calibration points may be eliminated from the calibration matrix. The elimination of the lowest quality calibration points not only may result in improvement in accuracy but also may reduce the runtime or storage complexity of the computation. For example, if initially 2000 calibration points for the computation of the location were considered, only 1500 calibration points will remain after the above elimination. Since location may be computed using fewer calibration points, the complexity in the computation may be reduced.

Next, at 340, determination of a contribution rank F of each of the remaining calibration points present in the calibration matrix D, after elimination of the low-quality calibration points, may be performed by the server 130. In order to determine the contribution rank, the server 130 may first calculate a Euclidean distance from each of the remaining set of calibration points to each other remaining calibration point of the plurality of calibration points based on the RSS values, which is in conjunction with above description. In an exemplary embodiment, the computed distance from each of the remaining set of calibration points dᵢ to each other remaining calibration point dⱼ may be stored in the following format

TABLE 3.3

| dis | d₁ | d₂ | d₃ | d₄ | d₅ | d₆ | d₇ | d₈ |
|---|---|---|---|---|---|---|---|---|
| d₁ | 0 | 5 | 4 | 2 | 6 | 1 | 7 | 5 |
| d₂ | 5 | 0 | 3 | 2 | 5 | 7 | 9 | 1 |
| d₃ | 4 | 3 | 0 | 7 | 2 | 6 | 8 | 5 |
| d₄ | 2 | 2 | 7 | 0 | 1 | 4 | 9 | 5 |
| d₅ | 6 | 5 | 2 | 1 | 0 | 3 | 7 | 4 |
| d₆ | 1 | 7 | 6 | 4 | 3 | 0 | 6 | 2 |
| d₇ | 7 | 9 | 8 | 9 | 7 | 6 | 0 | 10 |
| d₈ | 5 | 1 | 5 | 5 | 4 | 2 | 10 | 0 |

Based on the calculated Euclidean distance, a set of nearest calibration points of the remaining calibration points may be identified by the server 130 using the table 3.3. In the exemplary embodiment, the server 130 may identify the nearest neighbors of dᵢ and stores them in the following format:

In accordance with some embodiments, the set of nearest calibration points may be determined based on a Euclidean distance from each of the remaining set of calibration points to each other remaining calibration point and the set of nearest calibration points may be calibration points having a distance less than a threshold distance. In accordance with another embodiment, the set of nearest calibration points may be closest k calibration points. According to one embodiment, the closest k calibration points may be determined by use of k nearest neighbors algorithm. Further, the server 130 may determine a number of times each of the remaining set of calibration points of the plurality of calibration points exists as a point in the set of nearest calibration points. The contribution rank of a particular calibration point may represent a number of times that the particular calibration point mat fall within the nearest neighbors of other calibration points in the calibration matrix D. For example, as the calibration point d₁ was involved 4 times in the location computation procedure, as shown in table 3.4, the contribution rank of d₁ is 4.

Next, at 350, identification of a second set of calibration points from the remaining set of calibration points with the contribution rank less than a second threshold value may be performed by the server 130. The second set of calibration points may include non-active calibration points that may be determined based on the determined contribution rank. The non-active calibration points may be the calibration points that are unused in the computation of the location of the user device 110. In an exemplary embodiment, the server 130 may identify the second set of calibration points based on the lowest 25% of all contribution rank measurements.

Next, at 360, selection of a third set of calibration points from the remaining set of calibration points based on elimination of the second set of calibration points may be performed by the server 130. The third set of calibration points may correspond to the subset of the remaining set of calibration points used to determine the indoor location of user device 110. The subset of the remaining set of calibration points may include the calibration points that may be remaining after the elimination of the non-active calibration points.

Next, at 370, determination of the indoor location of the user device 110 based on the selected third set of calibration points may be performed by the server 130. In an exemplary embodiment, in response to the selection of the third set of calibration points, the location of the user device 110 may be determined as centroid of the nearest calibration points identified based on the RSS values and the position coordinates of the calibration points. In response to the determination of the location, the server 130 may send the determined location to the user device 110. The result of the location computation using the above mentioned technique may show that using this technique the server 130 will run with 50% of the original calibration points and performs comparable or better than the basic technique with the full calibration data such as improved accuracy in determination of location that is less than 2 meters and computation in milliseconds. For example, if we start with 2000 calibration points to compute the location of the user device 110 using this technique, we will be left with 1000 calibration points after eliminating inaccurate quality points and non-active points. Hence, the server will have lesser complexity since it is dealing with just these 1000 points. In another embodiment, the result of the location computation using the above-mentioned process shows that the server may run with 33%, 25%, 10% etc. of the original calibration points. In yet another embodiment, the result of the location computation using the above-mentioned process shows that the server may run with 60%, 70% etc. of the original calibration points.

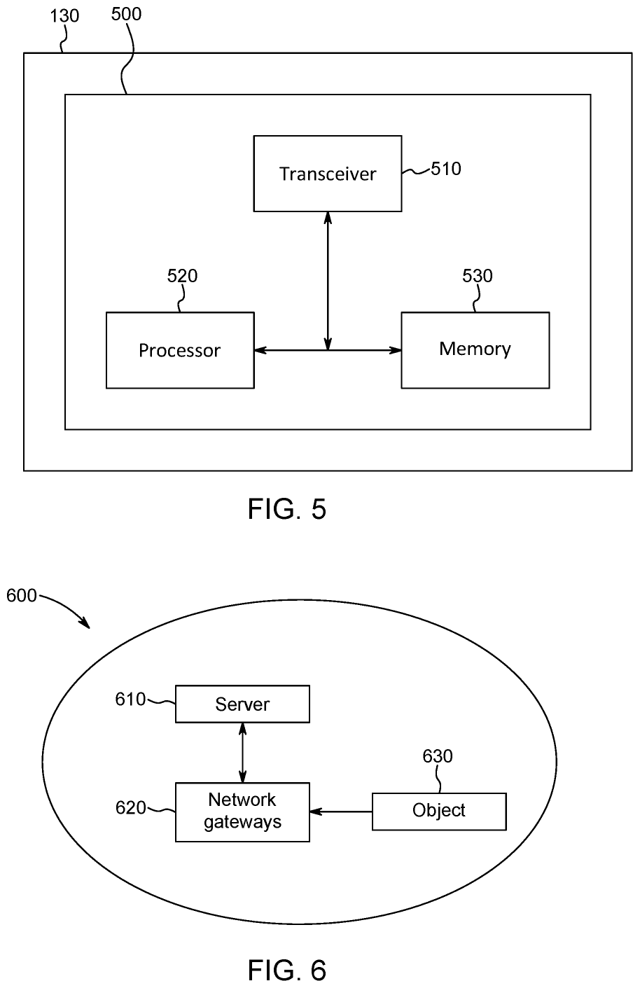

FIG. 4 illustrates a transactional diagram illustrating a determination of a location of a user device 110 based on an aspect of the present system or method. Initially, access points 120 may transmit 410 signals, which may be received by the user device 110. The user device 110 may then measure 420 RSS values of the received signals. As noted previously, the user device 110 may store the measured RSS values as a calibration data in its memory. Subsequently, the calibration data may be uploaded 430 to the server 130. At block 440, the server 130 may identify and eliminate inaccurate calibration points from a plurality of calibration points stored in a calibration matrix. In accordance with some embodiments, the identification and elimination of the inaccurate calibration points may include following operations, not necessarily in the same sequence:

1. Computation of a first distance from each calibration point to every other calibration point stored in the calibration matrix of FIG. 2 based on position coordinates. The first distance may be a Euclidean distance from each calibration point to every other calibration point based on the position coordinates, which is in conjunction with description of FIG. 3.

2. Computation of a second distance from each calibration point to every other calibration point stored in the calibration matrix of FIG. 2 based on RSS values of signals. The second distance may be a Euclidean distance from each calibration point to every other calibration point based on the RSS values, which is in conjunction with description of FIG. 3.

3. Determination of correlation between the first distance and the second distance to measure quality of each calibration points. The correlation may be determined between the Euclidean distance from each calibration point to every other calibration point calculated based on position coordinates and the Euclidean distance from each calibration point to every other calibration point calculated based on the RSS values, which is in conjunction with description of FIG. 3.

4. Identification of a first set of calibration points from the plurality of calibration points having quality less than a threshold value, which may be determined in conjunction with the determined correlation. The first set of calibration points may correspond to low-quality calibration points. Subsequently, the server 130 may eliminate the identified first set of the calibration points for usage in determination of the location of the user device 110. As a result, the lowest quality calibration points may be eliminated from the calibration matrix. The elimination of the lowest quality calibration points not only results in improvement in accuracy but also reduces the runtime or storage complexity of the computation.

At block 450, the server 130, in response to identification and elimination of inaccurate calibration points, may identify and eliminate non-active calibration points from the remaining set of calibration points. The identification and elimination of the non-active calibration points may include following operations, not necessarily in the same sequence:

1. Determination of a contribution rank of each of remaining calibration points present in the calibration matrix after elimination of the low-quality calibration points. In order to determine the contribution rank, the server 130 may calculate a Euclidean distance from each of the remaining set of calibration points to each other remaining calibration point based on the RSS values. Subsequently, the server 130 may identify for each of the remaining set of calibration points a set of nearest calibration points of the remaining calibration points. Further, the server 130 may determine a number of times each of the remaining set of calibration points exists as a point in the set of nearest calibration points. The contribution rank of a particular calibration point may represent a number of times that the particular calibration point falls within the nearest neighbors of other calibration points in the calibration matrix.

2. Identification of a second set of calibration points from the remaining set of calibration points with the contribution rank less than a second threshold value. The second set of calibration points may correspond to the non-active calibration points that may be determined based on the contribution rank. The non-active calibration points may be the calibration points that are unused in the computation of the location of the user device 110. Subsequently, the server 130 may eliminate the identified second set of calibration points from the remaining set of calibration points to select a third set of calibration points.

At block 460, the server 130 may determine the location of the user device 110 based on the selected third set of calibration points. Subsequently, the server 130 may transmit (470) determined location to the user device 110.

FIG. 5 illustrates a block diagram depicts a server 130 having at least a portion 500 in accordance with some embodiments. The portion 500 of the server 130 may include a transceiver 510 including a transmitter circuitry and a receiver circuitry (not shown), a processor 520, and a memory 530. Although not shown, the portion 500 of the server 130 also may include an antenna, an antenna switch, duplexer, circulator, or other highly isolative means for intermittently providing radio signals from the transmitter circuitry to the antenna and from the antenna to the receiver circuitry. The portion 500 of the server 130 may be an integrated unit containing at least all the elements depicted in FIG. 5, as well as any other elements necessary for the portion 500 of the server 130 to perform its particular electronic function. Alternatively, the portion 500 of the server 130 may comprise a collection of appropriately interconnected units or devices, wherein such units or devices perform functions that may be equivalent to the functions performed by the elements of the portion 500 of the server 130.

The transceiver 510 may enable the portion 500 of the server 130 to communicate signals to and from the access points 120 and to the user device 110. In this regard, the transceiver 510 may include appropriate, conventional circuitry to enable digital or analog transmissions over a wireless or wired link. The implementations of the transceiver may depend on the implementation of the portion 500 of the server 130. In accordance with some embodiments, the transceiver 510 may be capable of receiving signals from the access points 120 and the user device 110.

The processor 520 may include one or more microprocessors, microcontrollers, DSPs (digital signal processors), state machines, logic circuitry, or any other device or devices that process information based on operational or programming instructions. Such operational or programming instructions may be stored in the memory 530. The memory 530 can be an IC (integrated circuit) memory chip containing any form of RAM (random-access memory) or ROM (read-only memory), a floppy disk, a CD-ROM (compact disk read-only memory), a hard disk drive, a DVD (digital video disc), a flash memory card, external subscriber identity module (SIM) card or any other medium for storing non-transitory digital information. One of ordinary skill in the art will recognize that when the processor 520 has one or more of its functions performed by a state machine or logic circuitry, the memory 530 containing the corresponding operational instructions can be embedded within the state machine or logic circuitry. In accordance with some embodiments, the calibration matrix D (as shown in FIG. 2) may be stored in memory 530 of the server 130.

In accordance with some embodiments, the processor 520 of the server 130 may measure quality of each calibration point dᵢ stored in the calibration matrix D and may identify a first set of calibration points having quality (represented by SSDE(Λ_{geo}, Λ_{RSS})) less than a first threshold value from the plurality of calibration points may be included in the calibration matrix D. The processor 520 of the server 130 further may eliminate the first set of calibration points for usage in determination of the location of the user device 110 and may select a remaining set of calibration points from the plurality of calibration points, upon identification of the first set of calibration points with quality less than the first threshold value. In accordance with further embodiments, the processor 520 of the server 130 may determine contribution rank Γ of each of remaining calibration points present in the calibration matrix after elimination of the low-quality calibration points and may identify a second set of calibration points from the remaining set of calibration points with the contribution rank less than a second threshold value. Upon identification of the second set of calibration points, the processor 520 of the server 130 may select a third set of calibration points from the remaining set of calibration points by eliminating the second set of calibration points and may then determine the indoor location of the user device 110 based on the selected third set of calibration points. The determined indoor location may be then sent to the user device 110.

In accordance with some embodiments, the processor 520 of the server 130 may calculate a first distance from each of the plurality of calibration points to each other calibration point of the plurality of calibration points based on position coordinates of the plurality of calibration points. The position coordinates may comprise information about longitude and latitude positioning of the access points 120. The first distance may be a Euclidean distance from each of the plurality of calibration points to each other calibration point, wherein the first distance may be calculated as:

$$EucGeoDistance ( {d}_{i} , {d}_{j} ) = \sqrt{{( {longitude}_{i} - {longitude}_{j} )}^{2} + {( {latitude}_{i} - {latitude}_{j} )}^{2}} \qquad ( 4 )$$

and wherein

EucGeoDistance(dᵢ, dⱼ) is the Euclidean distance from dᵢ to dⱼ based on the position coordinates (longitude/latitude),

dᵢ is one calibration point of the plurality of calibration points, where i=(1, 2 . . . , m), and m is total number of calibration points,

dⱼ is one calibration point of the other calibration points, where j=(1, 2 . . . m).

The processor 520 of the server 130 may further calculate a second distance from each of the plurality of calibration points to each other calibration point of the plurality of calibration points based on received signal strength (RSS) values of signals received from the access points 120. The second distance may be a Euclidean distance from each of the plurality of calibration points to each other calibration point, wherein the second distance may be calculated as:

$$EucRSSDistance ( {d}_{i} , {d}_{j} ) = \sqrt{{( RSS {1}_{i} - RSS {1}_{j} )}^{2} + {( RSS {2}_{i} - RSS {2}_{j} )}^{2} + … + {( {RSSn }_{i} - {RSSn}_{j} )}^{2}} \qquad ( 5 )$$

and wherein

EucRSSDistance(dᵢ, dⱼ) is the Euclidean distance from dᵢ to dⱼ based on the RSS values,

RSS1, RSS2 . . . RSSn is signal strength values of the signals received from different access points (120a, 120b . . . 120n).

dᵢ is one calibration point of the plurality of calibration points, where i=(1, 2 . . . , m), and m is total number of calibration points.

dⱼ is one calibration point of the other calibration points, where j=(1, 2 . . . , m).

The RSS values of signals received at each of the plurality of calibration points may be stored in the calibration matrix (as shown in FIG. 2) of the server 130.

The processor 520 of the server 130 may then determine a correlation between the first distance and the second distance for each calibration point of the plurality of calibration points to measure the quality of each of the plurality of calibration points. The correlation between the first distance and the second distance may be determined as:

$$SSDE ( {Λ}_{geo} , {Λ}_{RSS} ) = {\sum }_{j}^{λ} {\sum }_{i}^{λ} {[ EucGeoDistance ( {Λ}_{geo}^{i} , {Λ}_{RSS}^{j} ) ]}^{2} , \qquad ( 6 )$$

and wherein

SSDE(Λ_{geo}, Λ_{RSS}) is sum square distances error between Λ_{geo} and Λ_{RSS},

EucGeoDistance (Λ_{geo}ⁱ, Λ_{RSS}^{j}) is the Euclidean distance from Λ_{geo}ⁱ to Λ_{RSS}^{j} points based on the position coordinates (longitude/latitude),Λ_{geo}ⁱ, Λ_{RSS}^{j} denotes the i^{th} and the j^{th} points in Λ_{geo} and Λ_{RSS} respectively,

where i=(1, 2 . . . , m) and j=(1, 2, . . . , m),

λ is nearest neighbor of dᵢ.

In accordance with further embodiments, the processor 520 of the server 130 may calculate a distance from each of the remaining set of calibration points to each other remaining calibration points and may identify for each of the remaining set of calibration points, a set of nearest calibration points of the remaining calibration points of the plurality of calibration points, based on the calculated distance. The set of nearest calibration points may be determined based on a Euclidean distance from each of the remaining set of calibration points to each other remaining calibration points, which may be based on the RSS values. The Euclidean distance may be computed in conjunction with the description of the FIG. 3. The processor 520 of the server 130 may then determine a number of times each of the remaining set of calibration points of the plurality of calibration points exists as a point in the set of nearest calibration points to determine the contribution rank of each of the remaining set of calibration points. The contribution rank of each of the remaining set of calibration points may correspond to the determined number of times.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure may be defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, or article that comprises, has, includes, contains a list of elements does not include only those elements but may include other elements not expressly listed or inherent to such process, method, or article. An element proceeded by “comprises . . . a”, “has . . . a”, “includes . . . a”, “contains . . . a” does not, without more constraints, preclude the existence of additional identical elements in the process, method, or article that comprises, has, includes, contains the element. The terms “a” and “an” are defined as one or more unless explicitly stated otherwise herein. The terms “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method described herein. Alternatively, some or all functions could be implemented by a state machine that has no stored program instructions, or in one or more application specific integrated circuits (ASICs), in which each function or some combinations of certain of the functions may be implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method to determine an indoor location of a user device, the method comprising:
measuring, by a server, quality of each of a plurality of calibration points stored in the server, wherein measuring the quality comprises:
calculating a first distance from each of the plurality of calibration points to each other calibration point of the plurality of calibration points;
calculating a second distance from each of the plurality of calibration points to each other calibration point of the plurality of calibration points; and
determining a correlation between the first distance and the second distance for each calibration point of the plurality of calibration points;
identifying, by the server, a first set of calibration points from the plurality of calibration points having the quality less than a first threshold value;
selecting, by the server, a remaining set of calibration points from the plurality of calibration points based on elimination of the first set of calibration points; and
determining, by the server, the indoor location of the user device based on a subset of the remaining set of calibration points of the plurality of calibration points.

2. The method of claim 1, wherein the calculation of the first distance is based on position coordinates of the plurality of calibration points.

3. The method of claim 2, wherein the first distance is a Euclidean distance from each of the plurality of calibration points to each other calibration point, wherein the first distance is calculated as:
$$EucGeoDistance ( {d}_{i} , {d}_{j} ) = \sqrt{{( {longitude}_{i} - {longitude}_{j} )}^{2} + {( {latitude}_{i} - {latitude}_{j} )}^{2}}$$
and wherein
EucGeoDistance(dᵢ, dⱼ) is the Euclidean distance from dᵢ to dⱼ based on the position coordinates (longitude/latitude),
dᵢ is one calibration point of the plurality of calibration points, where i=(1, 2 . . . , m), and m is total number of calibration points.
dⱼ is one calibration point of the other calibration points, where j=(1, 2 . . . , m).

4. The method of claim 3, wherein the calculation of the second distance is based on received signal strength (RSS) values of signals received from a plurality of access points (APs).

5. The method of claim 4, wherein the second distance is a Euclidean distance from each of the plurality of calibration points to each other calibration point, wherein the second distance is calculated as:
$$EucRSSDistance ( {d}_{i} , {d}_{j} ) = \sqrt{{( RSS {1}_{i} - RSS {1}_{j} )}^{2} + {( RSS {2}_{i} - RSS {2}_{j} )}^{2} + … + {( {RSSn }_{i} - {RSSn}_{j} )}^{2}}$$
and wherein
EucRSSDistance(dᵢ,dⱼ) is the Euclidean distance from dᵢ to dⱼ based on the RSS values, RSS1, RSS2 . . . RSSn is signal strength values of the signals received from different access points.
dᵢ is one calibration point of the plurality of calibration points, where i=(1, 2 . . . , m), and m is total number of calibration points.
dⱼ is one calibration point of the other calibration points, where j=(1, 2 . . . , m).

6. The method of claim 5, wherein the correlation between the first distance and the second distance is determined as:
$$SSDE ( {Λ}_{geo} , {Λ}_{RSS} ) = {\sum }_{j}^{λ} {\sum }_{i}^{λ} {[ EucGeoDistance ( {Λ}_{geo}^{i} , {Λ}_{RSS}^{j} ) ]}^{2} ,$$
and wherein
SSDE(Λ_{geo}, Λ_{RSS}) is sum square distances error between Λ_{geo} and Λ_{RSS},
EucGeoDistance (Λ_{geo}ⁱ, Λ_{RSS}^{j}) is the Euclidean distance from Λ_{geo}ⁱ to Λ_{RSS} points based on the position coordinates (longitude/latitude),
Λ_{geo} and Λ_{RSS} comprises a set of nearest calibration points, in descending order, from the plurality of calibration points based on the position coordinates (longitude/latitude) and RSS values respectively,
Λ_{geo}, Λ_{RSS} denotes the i^{th} and the j^{th} points in Λ_{geo} and Λ_{RSS} respectively, λ is nearest neighbor of dᵢ.

7. The method of claim 1 further comprising:
in response to the selection of the remaining set of calibration points, determining, by the server, a contribution rank of each of the remaining set of calibration points;
identifying, by the server, a second set of calibration points from the remaining set of calibration points with the contribution rank less than a second threshold value; and
selecting, by the server, a third set of calibration points from the remaining set of calibration points based on elimination of the second set of calibration points, wherein the third set of calibration points corresponds to the subset of the remaining set of calibration points used to determine the indoor location of user device.

8. The method of claim 7, wherein the determination of the contribution rank comprises:
calculating, by the server, a distance from each of the remaining set of calibration points to each other remaining calibration point of the plurality of calibration points;
based on the calculated distance, identifying by the server, for each of the remaining set of calibration points, a set of nearest calibration points of the remaining calibration points of the plurality of calibration points, wherein the set of nearest calibration points are determined based on a Euclidean distance from each of the remaining set of calibration points to each other remaining calibration point, and wherein the set of nearest calibration points are calibration points having a distance less than a third threshold value; and
determining, by the server, a number of times each of the remaining set of calibration points of the plurality of calibration points exists as a point in the set of nearest calibration points, wherein the contribution rank of each of the remaining set of calibration points corresponds to the determined number of times.

9. A system to determine an indoor location of a user device, the system comprising:
one or more processors;
an application executed by the one or more processors, wherein the one or more processors is configured to:
measure quality of each of a plurality of calibration points stored in a server, wherein to measure the quality the one or more processors is configured to:
calculate a first distance from each of the plurality of calibration points to each other calibration point of the plurality of calibration points;
calculate a second distance from each of the plurality of calibration points to each other calibration point of the plurality of calibration points; and
determine a correlation between the first distance and the second distance for each calibration point of the plurality of calibration points;
identify a first set of calibration points from the plurality of calibration points having the quality less than a first threshold value;
select a remaining set of calibration points from the plurality of calibration points based on elimination of the first set of calibration points; and
determine the indoor location of the user device based on a subset of the remaining set of calibration points of the plurality of calibration points.

10. The system of claim 9, wherein the calculation of the first distance is based on position coordinates of the plurality of calibration points.

11. The system of claim 10, wherein the first distance is a Euclidean distance from each of the plurality of calibration points to each other calibration point, wherein the first distance is calculated as:
$$EucGeoDistance ( {d}_{i} , {d}_{j} ) = \sqrt{{( {longitude}_{i} - {longitude}_{j} )}^{2} + {( {latitude}_{i} - {latitude}_{j} )}^{2}}$$
and wherein
EucGeoDistance(dᵢ, dⱼ) is the Euclidean distance from dᵢ to dⱼ based on the position coordinates (longitude/latitude),
dᵢ is one calibration point of the plurality of calibration points, where i=(1, 2 . . . , m), and m is total number of calibration points.
dⱼ is one calibration point of the other calibration points, where j=(1, 2 . . . , m).

12. The system of claim 11, wherein the calculation of the second distance is based on received signal strength (RSS) values of signals received at each of the plurality of calibration points from a plurality of access points (APs).

13. The system of claim 12, wherein the second distance is Euclidean distance from each of the plurality of calibration points to each other calibration point, wherein the second distance is calculated as:
$$EucRSSDistance ( {d}_{i} , {d}_{j} ) = \sqrt{{( RSS {1}_{i} - RSS {1}_{j} )}^{2} + {( RSS {2}_{i} - RSS {2}_{j} )}^{2} + … + {( {RSSn }_{i} - {RSSn}_{j} )}^{2}}$$
and wherein
EucRSSDistance(dᵢ, dⱼ) is the Euclidean distance from dᵢ to dⱼ based on the RSS values, RSS1, RSS2. . . . RSSn is signal strength values of the signals received from different access points,
dᵢ is one calibration point of the plurality of calibration points, where i=(1, 2 . . . m), and m is total number of calibration points.
dⱼ is one calibration point of the other calibration points, where j=(1, 2 . . . m).

14. The system of claim 13, wherein the correlation between the first distance and the second distance is determined as:
$$SSDE ( {Λ}_{geo} , {Λ}_{RSS} ) = {\sum }_{j}^{λ} {\sum }_{i}^{λ} {[ EucGeoDistance ( {Λ}_{geo}^{i} , {Λ}_{RSS}^{j} ) ]}^{2} ,$$
and wherein
SSDE(Λ_{geo}, Λ_{RSS}) is sum square distances error between Λ_{geo} and Λ_{RSS},
EucGeoDistance (Λ_{geo}ⁱ, Λ_{RSS}^{j}) is the Euclidean distance from Λ_{geo} to Λ_{RSS} points based on the position coordinates (longitude/latitude),
Λ_{geo} and Λ_{RSS} comprises a set of nearest calibration points, in descending order, from the plurality of calibration points based on the position coordinates (longitude/latitude) and RSS values respectively,
Λ_{geo}, Λ_{RSS} denotes the i^{th} and the j^{th} points in Λ_{geo} and Λ_{RSS} respectively, λ is nearest neighbor of dᵢ.

15. The system of claim 9, wherein the one or more processors is further configured to:
determine, in response to the selection of the remaining set of calibration points, a contribution rank of each of the remaining set of calibration points;
identify a second set of calibration points from the remaining set of calibration points with the contribution rank less than a second threshold value; and
select a third set of calibration points from the remaining set of calibration points based on elimination of the second set of calibration points, wherein the third set of calibration points corresponds to the subset of the remaining set of calibration points used to determine the indoor location of user device.
